(19) United States
(12) Patent Application Publication
(10) Pub. No.: US 2003/0081032 A1
(43) Pub. Date: May 1, 2003

(54) Printer

(76) Inventors: Masato Akitaya, Kanagawa (JP); Yumiko Yamaguchi, Kanagawa (JP)

Correspondence Address: PATENTS+TMS, A Professional Corporation, 1914 North Milwaukee Avenue, Chicago, IL, 60647, US

(21) Appl. No.: 10/284,981

(22) Filed: Oct. 31, 2002

(30) Foreign Application Priority Data
Oct. 31, 2001 (JP) 2001-335039

(51) Int. Cl. B41J 2/205

(52) U.S. Cl. 347/15

(57) ABSTRACT

Disclosed is a printer having image processing means. The image processing means includes a microcomputer and an image processing block. The image processing block carries out color conversion processing to convert image data for color display, which is comprised of a plurality of colors, into image data for color printing, which is comprised of a plurality of colors corresponding to the plurality of colors of the image data for color display, respectively. The image processing block has an operation block for carrying out at least a part of the color conversion processing according to color conversion formulas for converting the image data for color display into the image data for color printing. The image processing means is configured so as to convert the image data for color display into the image data for color printing, which is comprised of a plurality of colors corresponding to the plurality of colors of the image data for color display, respectively, by using the operation block or sharing the operation block in a time division manner.

### FIELD OF THE INVENTION

The present invention relates to a printer.

### DESCRIPTION OF THE PRIOR ART

When a printer is used to print on paper a color image displayed on a display device such as a cathode-ray tube (CRT), color in the printed image may differ from that shown on the display device. Differences in colors printed on paper from those shown on a display device depend on the color characteristics of the printer.

A variety of image processing operations can be employed, taking into account color characteristics of a printer, to ensure that a printed color matches that shown on an image display. Such operations, which are generally performed in printers, include color conversion processing, wherein print image data processing is carried out prior to printing.

Referring to the flowchart shown in FIG. 12, example of image processing performed in a printer will now be described. The flowchart of FIG. 12 illustrates the steps of an image processing operation for converting to image data for printing (on printer) video signals displayed on a display means.

In the example shown in FIG. 12, composite National Television System Committee (NTSC) standards video signals are composed of image data (luminance signal Y, color-difference signals Cb (=Y−B) and Cr (=Y−R)) for 30 frames of image (still images). A single frame is composed of an even and odd field images, and these field images are interlaced using interlace scanning.

As shown in the flowchart of FIG. 12, when NTSC video signal image data is converted into RGB image data for printing, image data for each frame is sequentially taken in (input) and stored in a frame memory (i.e., a memory device for storing frame data, that is not shown in FIG. 12) (step S201). At this point, image data of luminance signal Y, color-difference signals Cb and Cr of each even and odd field is stored in the frame memory.

Next, image data comprising even and odd fields stored in the frame memory is sequentially changed in order of image scanning lines to provide an image consisting of a single frame (step S202). Then, image rotating processing is carried out in accordance with a printing direction of a printer (step S203), after which the luminance signal Y and the color-difference signals Cb and Cr are converted into RGB image data, and a first edge processing for sharpening (emphasizing) an edge of the image to be printed is carried out (step S205).

Following this, color conversion processing mentioned above is carried out (step S206). For example, color conversion processing for image data B is carried out based on color conversion formulas (1)-(7) shown below; and color conversion processing for each of image data G and R is also carried out using similar formulas. Thus,

ANS1=(RegA−RegB)*f(G)+RegB (1)

ANS2=(RegC−RegD)*f(G)+RegD (2)

ANS3=(RegE−RegF)*f(G)+RegF (3)

ANS4=(RegG−RegH)*f(G)+RegH (4)

ANS5=(ANS2−ANS1)*f(R)+ANS1 (5)

ANS6=(ANS4−ANS3)*f(R)+ANS3 (6)

ANS7=(ANS6−ANS5)*f(G)+ANS5 (7)

where RegX (X=A−H) is a value of a register for storing compensating coefficients for converting original image data RGB for display into converted image data RGB for printing. The compensating coefficients are assigned values such that converted image data RGB for printing is obtained from the original image data RGB for display on the basis of color characteristics of the printer. Further, f(G), f(B) and f(R) are coefficients (values) obtained by carrying out a given operation processing with respect to the original image data.

Finally, a second edge processing is carried out with respect to the converted image data, thereby obtaining image data for printing (step S207).

It is to be noted that in a conventional printer the above image processing steps are generally performed using software. However, the use of software to perform such processing steps requires an expensive, high-speed microcomputer. Alternatively, most of the above-mentioned image processing steps may be carried out using hardware by way of a dedicated chip for image processing (semiconductor chip (IC)). In this case, a versatile chip or a custom IC may be used as the dedicated chip for image processing.

In the case of using software processing to carry out the above-mentioned steps, there is an advantage in which image processing or image data modification can be carried relatively easily. However, since parallel processing cannot be utilized to carry out such software processing, and a time taken to calculate each step to be carried out in the image processing operation shown in the flowchart of FIG. 12 depends on a clock cycle speed of a microcomputer used, if a low-cost, and therefore comparatively slow microcomputer is used, a time taken to execute the required steps for image processing will be considerable, and therefore impractical.

In contrast, in the case of using hardware processing to carry out the above-mentioned steps, a time taken to complete image processing steps can be greatly reduced since a fast operation speed can be attained, and parallel processing employed. However, in a case of using hardware processing, a problem arises that a circuit employed for image processing is necessarily complicated and large, which results in high production costs of a printer.

### SUMMARY OF THE INVENTION

It is therefore an object of the present invention to provide a printer that has a simple circuit structure and a low production cost, and that can carry out image processing including color conversion processing in a relatively short time (i.e., at a high speed).

In order to achieve the above object, the present invention is directed to a printer that has image processing means for carrying out given image processing. In an embodiment of the present invention, the image processing means of the printer comprises: a microcomputer; and an image processing block for carrying out color conversion processing to convert image data for color display, which is comprised of a plurality of colors, into image data for color printing, which is comprised of a plurality of colors corresponding to the plurality of colors of the image data for color display, respectively, the image processing block having an operation block for carrying out at least a part of the color conversion processing according to color conversion formulas for converting the image data for color display into the image data for color printing. The image processing means is configured so as to convert the image data for color display, which is comprised of a plurality of colors, into the image data for color printing, which is comprised of a plurality of colors corresponding to the plurality of colors of the image data for color display, respectively, using the operation block.

In another embodiment of the present invention, the image processing means comprises: a microcomputer; and an image processing block for carrying out color conversion processing to convert image data for color display, which is comprised of a plurality of colors, into image data for color printing, which is comprised of a plurality of colors corresponding to the plurality of colors of the image data for color display, respectively, the image processing block having an operation block for carrying out at least a part of the color conversion processing according to color conversion formulas for converting the image data for color display into image data for color printing. The image processing means is configured so as to convert the image data for color display into the image data for color printing by sharing the operation block in a time division manner.

In a further embodiment of the present invention, a printer comprises an image processing block having an operation block for carrying out color conversion processing to convert image data for color display, which is comprised of a plurality of colors, into image data for color printing, which is comprised of a plurality of colors corresponding to the plurality of colors of the image data for color display, respectively, according to color conversion formulas for converting the image data for color display into image data for color printing, wherein the image processing means is configured so as to convert image data for color display into the image data for color printing by sharing the operation block in a time division manner.

In this invention of each of the above-mentioned embodiments, it is preferred that the color conversion formulas consist of a plurality of operation formulas, and the operation block comprises at least one operation circuit for carrying out operations based on the plurality of operation formulas. Further, in this invention, it is also preferred that the plurality of operation formulas include a plurality of operation formulas each having an identical form.

Moreover, in this invention, it is preferred that the operation block comprises at least one operation circuit for carrying out operations based on the plurality of operation formulas, in which the operations are carried out sequentially by sharing the operation circuit in a time division manner.

Further, in this invention of each of the above-mentioned embodiments, it is preferred that the color conversion formulas consist of a plurality of operation formulas, and the operation block comprises a plurality of operation circuits each of which carries out an operation based on the plurality of operation formulas. In this case, the plurality of operation formulas may include a plurality of operation formulas each having an identical form.

Moreover, in this invention of each of the above-mentioned embodiment, it is preferred that the plurality of colors include red, green and blue, and the image processing block is configured so as to carry out the color conversion processing by sharing the operation block in a time division manner for image data for at least two colors selected from red, green and blue.

In this invention of each of the above-mentioned embodiment, it is preferred that the image processing block further comprises a semiconductor memory for storing compensating coefficients to be used in the color conversion formulas, and the image processing block carries out the color conversion processing according to the color conversion formulas using the compensating coefficients stored in the semiconductor memory.

In this invention of each of the above-mentioned embodiment, the printer further comprises a head for exposure on which one or more light sources for emitting red light, one or more light sources for emitting green light, and one or more light sources for emitting blue light are provided. In this case, the printer is configured to reproduce an image on a photosensitive printing paper by exposing the photosensitive printing paper by means of the head for exposure.

In this invention of each of the above-mentioned embodiment, the printer may be configured so as to reproduce an image on a printing paper that contains a plurality of photosensitive microcapsules.

Also, in this invention of each of the above-mentioned embodiment, the printer may be a Cycolor type printer.

These and other objects, structures and advantages of the present invention will be apparent from the following description of the preferred embodiment when it is considered taken in conjunction with the appended drawings.

### BRIEF DESCRIPTION OF THE DRAWINGS

FIG. 1 is a block diagram illustrating embodiments of a printer according to the present invention.

FIG. 2 is a timing chart illustrating a timing-relation between two encoded pulses FG1 and FG2 and an LR signal in the printer shown in FIG. 1.

FIG. 3 is a bottom plan view illustrating one example of a structure of an LED head in the printer shown in FIG. 1.

FIG. 4 is a block diagram illustrating an example of the structure of one principal part of gate IC in the printer shown in FIG. 1.

FIG. 5 is a timing chart illustrating a timing-relation between image data and an LED control signal in the printer shown in FIG. 1.

FIG. 6 is a timing chart illustrating a timing-operation of setting image data to a first group of registers in the printer shown in FIG. 1.

FIG. 7 is a timing chart illustrating a timing-operation for holding image data in a second group of registers in the printer shown in FIG. 1.

FIG. 8 is a block diagram illustrating one embodiment of an image processing circuit in a printer according to the present invention.

FIG. 9 is a block diagram illustrating an embodiment of an image processing block in the image processing circuit of the printer according to the present invention.

FIG. 10 is a flowchart illustrating an operation of the image processing circuit shown in FIG. 8.

FIG. 11 is a block diagram illustrating another embodiment of an image processing block in the image processing circuit in a printer according to the present invention.

FIG. 12 is a flowchart illustrating each step in image processing including color-conversion processing for converting video signals for display on display means to image data for printing on a printer.

### DETAILED DESCRIPTION OF THE PREFERRED EMBODIMENTS

With reference to the appended drawings, a detailed description of the preferred embodiment of a printer according to the present invention will be given below.

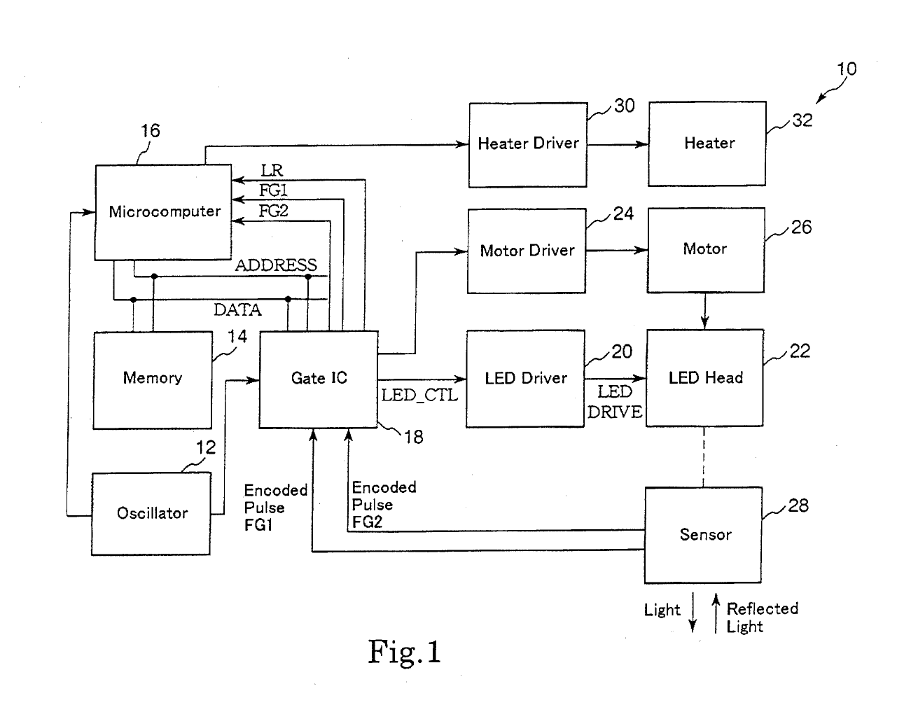

FIG. 1 is a block diagram illustrating an embodiment of a printer according to the present invention.

The printer 10 shown in FIG. 1 reproduces (prints out) an image corresponding to image data received from an image data source, which supplies the image data, on a photosensitive printing paper. As shown in FIG. 1, the printer 10 comprises: an oscillator 12; a memory 14; a microcomputer 16; a gate IC (digital IC) 18; an LED driver 20; an LED head 22 (optical head for exposing), which is a head for the printer; a motor driver 24 and a motor 26; a linear encoder (not shown) having a linear scale and a linear sensor 28; and a heater driver 30 and a heater 32.

Here, the image data is supplied by a digital device such as a personal computer (PC), or a digital camera, which can handle image data as digital data; or is supplied by an analog device such as a video player (VCR), or a television set (TV), which can handle image data as video signals, compatible with systems such as NTSC and PAL.

The printer 10 is connected to a digital device such as a PC via a parallel port. The digital data transmitted by the digital device via serial communication or the like is received by the printer 10 as image data. Also, the printer 10 is connected to an analog device such as a VCR via a video terminal. The video signals transmitted by the analog device are received by the printer 10 as image data.

In addition, as mentioned above, the image data source may be either a digital or an analog device. In practice, any device that can transmit image data to the printer 10 can be utilized as an image data source. Similarly, a system for connecting the printer 10 to the image data source is not limited to any one interface; and thus image data formats can be transmitted using any well-known communication protocol and interface standard.

Further, in the printer 10 various types of photosensitive printing papers can be used; such as a printing paper coated with photosensitive microcapsules (cyliths) (Cycolor® medium, Cycolor type printing paper), and Polaroid® film, both of which are known.

Still further, (not shown in FIG. 1) the printer 10 is provided with power supply circuits for supplying power at a given voltage to various sections as mentioned above; an interface circuit for interfacing between the printer 10 and the image data source; a video decoder for decoding the video signals, and converting image data to digital data; a pick-up mechanism (initial feed mechanism); and a mechanism for feeding a printing paper.

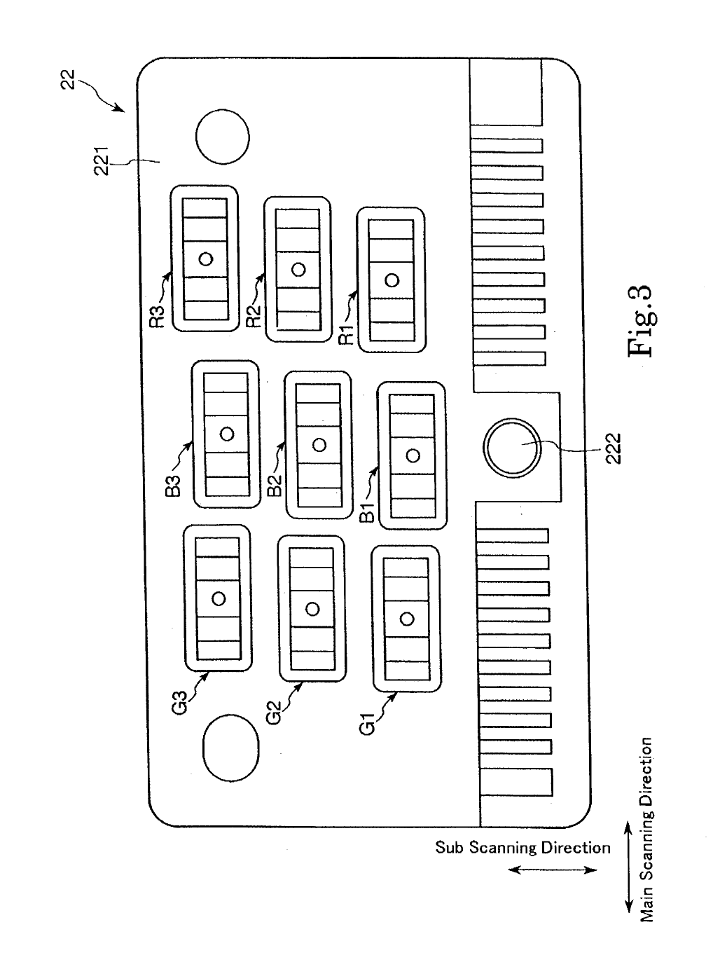

In the present embodiment, the printer 10 is a Cycolor type printer that reproduces an image on a printing paper coated with photosensitive microcapsules (Cycolor mediums). In the printer 10 a pressure mechanism 222 is provided for mechanically pressurizing an exposed printing paper to develop an image (developing process) (see FIG. 3). The pressure mechanism 222 may be either spherical or cylindrical in form.

Hereinafter, each of the elements of the printer 10 will be described in turn.

In the printer 10 shown in FIG. 1 the oscillator 12 generates clock signals having a predetermined frequency. These clock signals are supplied to elements of the printer 10 via the microcomputer 16 and the gate IC 18, whereby such elements are caused to operate synchronously.

The memory 14 is a buffer for storing the image data transmitted from the image data source. The memory 14 may comprise any known semiconductor memory. Examples include various types of RAM (Random Access Memory) such as SRAM (Static RAM), and DRAM (Dynamic RAM); and nonvolatile memories such as EPROM (Erasable Programmable Read-Only Memory), EEPROM (Electrically Erasable Programmable Read-Only Memory); and also flash memory.

The microcomputer 16 detects coordinate positions of a plurality of LEDs mounted on the LED head 22, and functions to control communication of image data from the image data source; the heater driver 30; LED current (light intensity of an LED); and the mechanical elements, such as the pick-up mechanism of a printing paper and the mechanism for feeding a printing paper. Further, the microcomputer 16 is able to detect operation errors that may occur in the printer 10.

The gate IC 18 functions to control the LED driver 20; the motor 26 via the motor driver 24 (motor servo); and the memory 14.

The microcomputer 16, the memory 14, and the gate IC 18 are connected to each other via an address bus “ADDRESS” and a data bus “DATA”. The image data stored in the memory 14 can be accessed by both the microcomputer 16 and the gate IC 18 via the address bus “ADDRESS” and the data bus “DATA.”

The image data supplied from the image data source is transmitted from microcomputer 16 to the memory 14 via the data bus “DATA,” and is written (stored) in a given address specified in the memory 14.

During printing of an image onto a printing paper, the microcomputer 16 reads out image data stored in the memory 14, and the read-out image data is then transmitted along with its corresponding address data to the gate IC 18.

A control means for controlling the driving of the printer 10 includes the microcomputer 16 and the gate IC 18.

In the preceding description of the present embodiment, a variety of functions are shared by the microcomputer 16 and the gate IC 18, but as will be apparent to one skilled in the art sharing of such functions is susceptible to a variety of modifications, as required.

The LED head 22 is able to expose a printing paper, and is provided with one or more LED(s) (R-LED) emitting red light; one or more LED(s) (G-LED) emitting green light; and one or more LED(s) (B-LED) emitting blue light. The gate IC 18 controls the driving (for example, the emission timing) of these LEDs at the LED head 22 via the LED driver 20.

In the present invention, the LED head 22 may be provided with only one LED corresponding to each color (red, green and blue), i.e., R-LED, G-LED and B-LED; or, alternatively, it may be provided with a plurality of LEDs, each corresponding to any one or two such colors; or may be provided with a plurality of LEDs, each of which may correspond to any one such color. By enabling a plurality of LEDs to correspond to any one color, it is possible to increase a printing speed, and thereby enable printing of a high-resolution image, even in a case that adequate light is lacking. It is also to be noted that in the present embodiment, the LED head 22 is provided with three LEDs, corresponding to any one color (see FIG. 3).

In the present embodiment, the head for a printer (printer head) is not limited to the LED head 22 (i.e., the light source is not limited to the LED), and any printer head known in the art (for exposure) may be used that is capable of utilizing a light source of a predetermined wavelength for exposure of a photosensitive printing paper.

It should also be noted here that a printer head for use in the present embodiment is not limited to that described above for exposure.

The motor 26 is driven by the motor driver 24 under control of the gate IC 18. During a printing operation, the motor 26 is driven to pick up individual sheets of printing paper from a storage section by means of the pick-up mechanism (not shown), which mechanism has an initial predetermined setting. The LED head 22 is caused to reciprocate (move) at a given constant speed in a main scanning direction by means of a head moving mechanism, for example, a gear mechanism (not shown). During this operation, the printing paper is fed by a printing paper feeding mechanism (not shown) in a sub scanning direction substantially perpendicular to the main scanning direction. At this stage, the printing paper is exposed by the LED head 22, and a latent image corresponding to the image data is recorded (formed) on the printing paper.

The linear scale and the sensor 28 are utilized to detect a position (coordinate position) of the LED head 22 in the main and sub scanning directions with respect to a printing paper, i.e., to detect each dot (pixel) during a reciprocating motion of the LED head 22, and to detect a moving direction of the LED head 22 with respect to the printing paper.

The linear scale is utilized in an encoder provided with a plurality of monochrome patterns in bar form. The linear scale is placed at a predetermined position spaced apart from the LED head 22, in such a way that the LED head 22 can be moved in the main scanning direction relative to the linear scale. The patterns of the linear scale maintain a predetermined constant interval (a predetermined pitch) along the moving direction of the LED head 22 (i.e., along the main scanning direction). Here, in the present embodiment, the pitch of the patterns corresponds to the pitch of the pixel of an image.

On the other hand, the sensor 28 has an emitting section for emitting light toward the linear scale and a plurality of receiving sections for receiving reflected light, which is emitted from the emitting section and reflected from the encoder. The received light then undergoes photoelectric-transfer.

Here, an LED (light emitting diode) can be used as the emitting section, and a photodiode or a phototransistor can be used as the receiving section.

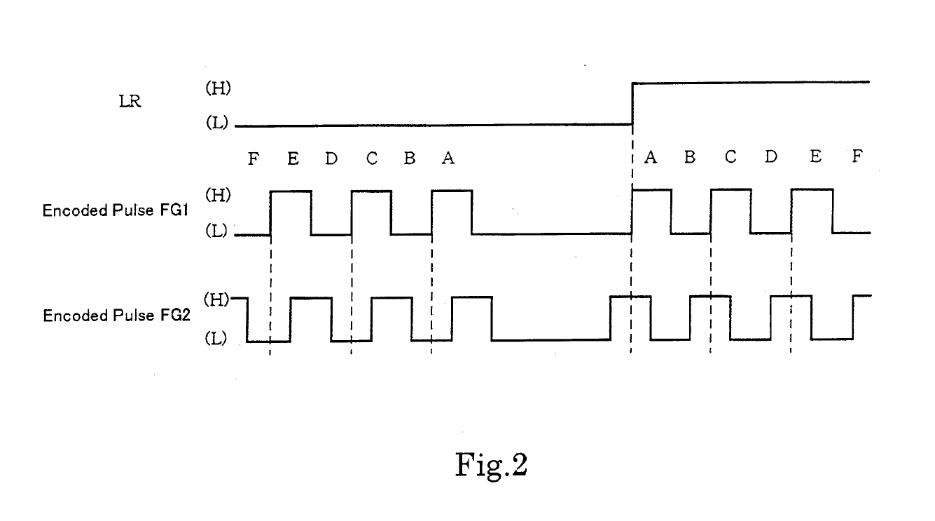

In the present embodiment, the LED head 22 and the sensor 28 are integrated in a carriage (not shown). As the carriage (i.e., the LED head 22) is moved, the sensor 28 outputs two encoded pulses FG1 and FG2, which have phases that shift relative to each other by 90 degrees, as shown in the timing chart in FIG. 2. Both the encoded pulses FG1 and FG2 are supplied to the gate IC 18.

One cycle of the encoded pulse FG1 or FG2, which is the combined period of the duration of a high level (H) and the duration of a low level (L), corresponds to a time required for scanning (or moving over) two dots of an image (i.e., twice the pitch existing between two adjacent dots) in the main scanning direction.

When the LED head 22 moves in a predetermined direction, the phase of the encoded pulse FG1 lags 90 degrees behind the phase of the encoded pulse FG2; and when the LED head 22 moves in a corresponding reverse direction, the phase of the encoded pulse FG1 precedes by 90 degrees the phase of the encoded pulse FG2.

As shown in the timing chart in FIG. 2, the gate IC 18 latches a level of the encoded pulse FG2 at a rising edge of the encoded pulse FG1 input by the sensor 28, and then outputs an LR signal to the microcomputer 16.

One cycle of the LR signal, which is the combined period of the duration of a high level and the duration of a low level, corresponds to a time required for scanning (feeding) dots corresponding to two lines of an image (i.e., twice the pitch existing between two adjacent dots) in the sub scanning direction.

The moving direction of the LED head 22 is detectable (distinguished) by using the LR signal. Namely, when a level of the LR signal is low, a moving direction of the LED head 22 is determined to be in a certain direction (for example, to the right of the LED head 22, as shown in FIG. 3). Conversely, when a level of the LR signal is high, movement in a reverse direction is determined (for example, to the left of the LED head 22).

When movement of the LED 22 is reversed during a turnback period, levels of both the encoded pulses FG1 and FG2 in FIG. 2 remain low for a while. Namely, the moving direction of the LED head 22 is switched (reversed) in the turnback period.

The LR signal and the encoded pulses FG1 and FG2 mentioned above are supplied to the microcomputer 16.

The microcomputer 16 detects a direction in which the LED head 22 is moving, and also a position (coordinate position) of both main and sub scanning directions of the LED head 22 (i.e. an area of the LED head 22) based on the LR signal and the encoded pulses FG1 and FG2. In fact, the microcomputer 16 detects a direction in which the LED head 22 is moving, on the basis of the LR signal and the encoded pulse FG2. Further, the microcomputer 16 sequentially detects (calculates) the coordinate positions of the plurality of LEDs mounted on the LED head 22 in the main and sub scanning directions by counting the number of pulses of the encoded pulse FG1 and the LR signal.

The microcomputer 16 also sequentially reads out from the memory 14 image data corresponding to the calculated coordinate positions of the plurality of LEDs, and supplies the image data and the address data indicating the LED corresponding to the image data to the gate IC 18 to thereby set the image data in a first group of registers, as mentioned hereinafter.

While in the present embodiment, the printer 10 is configured such that the microcomputer 16 calculates the coordinate positions of the plurality of LEDs, so as to manage image data, it will be apparent to those skilled in the art that the present invention is in no way limited thereto. For example, the printer 10 of the present invention may include a computing device for calculating coordinate positions and setting image data in a first group of registers.

While the microcomputer 16 uses sequential processing, a computing device may be employed that uses parallel processing, whereby all coordinate positions of the plurality of LEDs can be calculated at high speed. By employing such a computing device a printer can be provided that is able to rapidly calculate coordinate positions in a short time. Consequently, the microcomputer 16 is not required to have a high processing speed, and inexpensive microcomputers having a relatively low processing speed can be utilized, thereby reducing a cost of the printer 10. Further, in a printer having such a computing device, since the LED head 22 can be moved more rapidly, a number of LEDs mounted on the LED head 22 can be increased, thereby enabling printing at a higher resolution to be carried out in a relatively short period of time.

Such a computing device may be provided either separately from or integral to the gate IC 18.

In the printer 10 shown in FIG. 1, following exposure and development of ink, the heater 32 is used to heat a sheet of printing paper to harden the ink (image). The microcomputer 16 controls, via the heater driver 30, operations of the heater 32 (e.g., timing of heating).

Next, a structure of the LED head 22 in the printer 10 will be described. FIG. 3 is a bottom plan view illustrating an example of a structure of the LED head.

As shown in FIG. 3, in the present embodiment the LED head 22 comprises a head base 221, on which a total of nine LEDs (R1-R3, G1-G3, and B1-B3) are provided. The nine LEDs include three LEDs R1-R3 for emitting red light, three LEDs G1-G3 for emitting green light, and three LEDs B1-B3 for emitting blue light.

As shown in FIG. 3, the nine LEDs are provided in a form of a 3×3 matrix (tri-diagonal matrix) on the head base 221, and are arranged so as to be offset from each other by a predetermined number of dots in both a main and a sub scanning direction.

Namely, the LEDs R3, B3, and G3 of FIG. 3 are arranged in a top row of the matrix so as to be offset respectively by a predetermined number of dots in a vertical direction (sub scanning direction). In a case that in the structure shown in FIG. 3 the LED G3 is placed in a central vertical position relative to the LEDs of the top row of the matrix, the LED R3 is placed at a position above the LED G3, corresponding to a predetermined number of dots; and the LED B3 is placed at a position below the LED G3, corresponding to a predetermined number of dots.

Further, as shown in FIG. 3, LEDs R2, B2, and G2 are arranged in order in the middle row of the matrix so that they are offset respectively by a predetermined number of dots in the vertical direction, in the same manner as is utilized for the top row. Moreover, as is also shown in FIG. 3, LEDs R1, B1, and G1 are arranged in order in the bottom row of the matrix so that they are offset by a predetermined number of dots in the vertical direction, in the same manner as is utilized for the top and middle rows.

Further, as shown in FIG. 3, the LEDs R3, R2, and R1 are arranged in order in the right column of the matrix so that they are offset by a predetermined number of dots in the left-right direction (the main scanning direction). With regard to the structure shown in FIG. 3, the LED R2 occupies a central position in the horizontal direction in the right column of the matrix, the LED R1 is placed to the left of the LED R2 by a predetermined number of dots, and the LED R3 is placed to the right of the LED R2 by a predetermined number of dots.

Moreover, as shown in FIG. 3, the LEDs B3, B2, and BI are arranged in order in the middle column of the matrix so that they are offset by a predetermined number of dots in the left-right direction, in the same manner as the right column. Similarly, as shown in FIG. 3, the LEDs G3, G2, and G1 are arranged in the left column of the matrix so that they are offset in order by a predetermined number of dots in the left-right direction in the same manner as the middle and right columns.

As mentioned above, the printer 10 of the present embodiment causes the LED head 22 to move in the main scanning direction, and causes the printing paper to move in the sub scanning direction. In this case, a latent image is recorded on a photosensitive printing paper by sequentially emitting light for each color corresponding to image data for a required time corresponding to image data onto the photosensitive printing paper by means of the nine LEDs R1-R3, G1-G3, and B1-B3 mounted on the LED head 22 and thereby two-dimensionally exposing the photosensitive printing paper.

In other words, a latent image corresponding to image data is recorded on each dot of the printing paper by sequentially emitting light from each of the LEDs R1-R3, G1-G3, and B1-B3 mounted on the LED head 22. In this regard, it is to be noted that the image data that is set in each of the three LEDs R1-R3 is identical for each dot (the same image data is set in each of the three LEDs R1-R3). Similarly, for each dot, the image data that is set in each of the three LEDs G1-G3 is identical, and the image data that is set in each of the three LEDs B1-B3 is identical.

Here, as shown in FIG. 3, since each of the LEDs is offset relative to one another in the sub scanning direction in the LED head 22, a time interval exists between the exposure of red light by means of the LED R3 and the exposure of green light by means of the LED G3, which corresponds to a time when the LED head 22 moves in more than a predetermined number of lines. Also, a time interval exists between the exposure of green light by means of the LED G3 and the exposure of blue light by means of the LED B3, which corresponds to a time when the LED head 22 moves in more than a predetermined number of lines.

Sensibility of photosensitive microcapsules coated on a printing paper can be enhanced by exposing them to light emissions at regular intervals rather than to continuous light emission. Thus, by offsetting the positions of the LEDs in the sub scanning direction as in the LED head 22 shown in FIG. 3, sensibility of microcapsules coated on a printing paper can be enhanced.

It is to be noted that an arrangement of LED relative to one another (spacing or shift-length) is not limited to that described above, and may be modified if necessary.

On the head base 221 the pressure mechanism 222 is provided, which acts to mechanically exert a pressure on an exposed printing paper to thereby develop an image (developing process). As shown in FIG. 3, the pressure mechanism 222 is provided at a position lower than that of the head base 221.

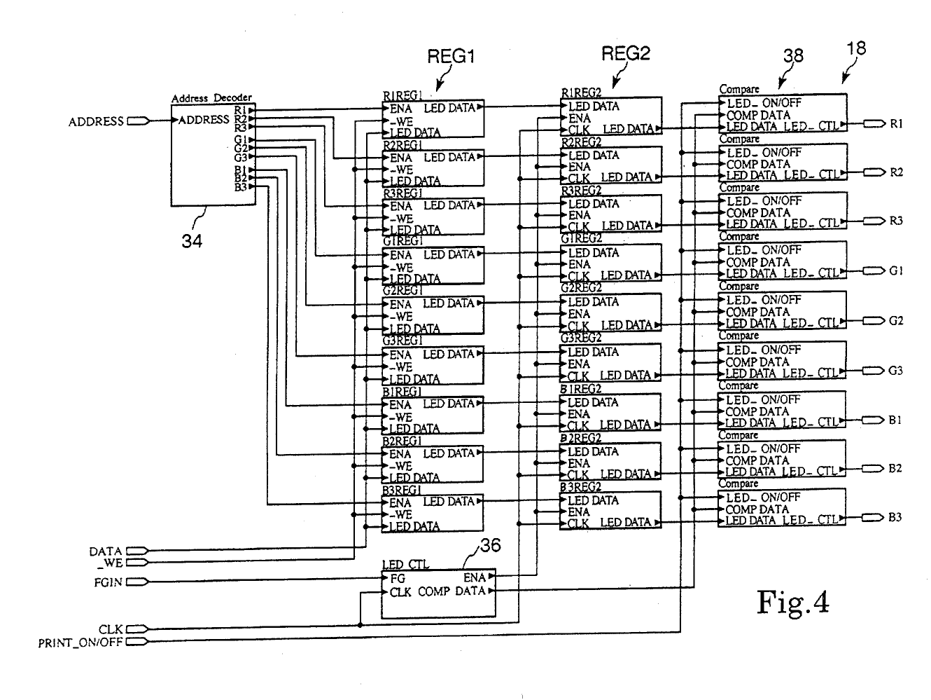

Next, an internal structure of the gate IC 18 in the printer 10 will be described. FIG. 4 is a block diagram illustrating an example of the structure of a principal part of the gate IC 18 in the printer 10 shown in FIG. 1.

The parts, which control the LED driver 20 within the gate IC 18, are shown in FIG. 4. As shown in FIG. 4, the gate IC 18 comprises an address decoder 34; an LED control circuit 36; a first group of registers REG1; a second group of registers REG2; and a group of comparators 38. For the sake of simplicity, components of the gate IC 18 other than those described above are omitted in the following explanation.

The microcomputer 16 inputs image data “LED DATA” to the first group of registers REG1 via a data bus “DATA.” The microcomputer 16 also inputs an address signal that specifies the LED (i.e., a first register) corresponding to the image data “LED DATA” to the address decoder 34 via an address bus “ADDRESS.” In addition, the image data “LED DATA” that is input to the first group of registers REG1 image data R, G and B for printing after conversion, as will hereinafter be described.

The address decoder 34 decodes the address signal input by the microcomputer 16 via the address bus “ADDRESS,” and outputs an enable signal “ENA” to designate (select) a first register corresponding to the address signal in the first group of registers REG1.

The register designated by the “ENA” fetches and latches “LED DATA” output at this stage to the data bus “DATA”.

The LED control circuit 36 generates the enable signal “ENA” and comparative data “COMP DATA” based on either the encoded pulse FG1 or FG2, which is input by the sensor 28 (hereinafter, collectively referred to as an encoded pulse “FG”), and outputs them to the second group of registers REG2 and the group of comparators 38, respectively.

The enable signal “ENA” output from the LED control circuit 36 is a timing signal used to hold the image data “LED DATA,” which is set in the first group of registers REG1 and then transferred from the first group of registers REG1 to the second group of registers REG2 in parallel. The “ENA” is output at a predetermined timing after exposure of nine dots at a position of an immediately preceding dot is completed.

Further, the comparative data “COMP DATA” is utilized to determine timings when the nine LEDs R1-R3, G1-G3, and B1-B3 emit light, by comparing the comparative data “COMP DATA” with the image data “LED DATA,” which data is held in the second group of registers REG2. The comparative data “COMP DATA” is generated by counting clock signals “CLK” in synchronization with the encoded pulse “FG,” and is output to the group of comparators 38.

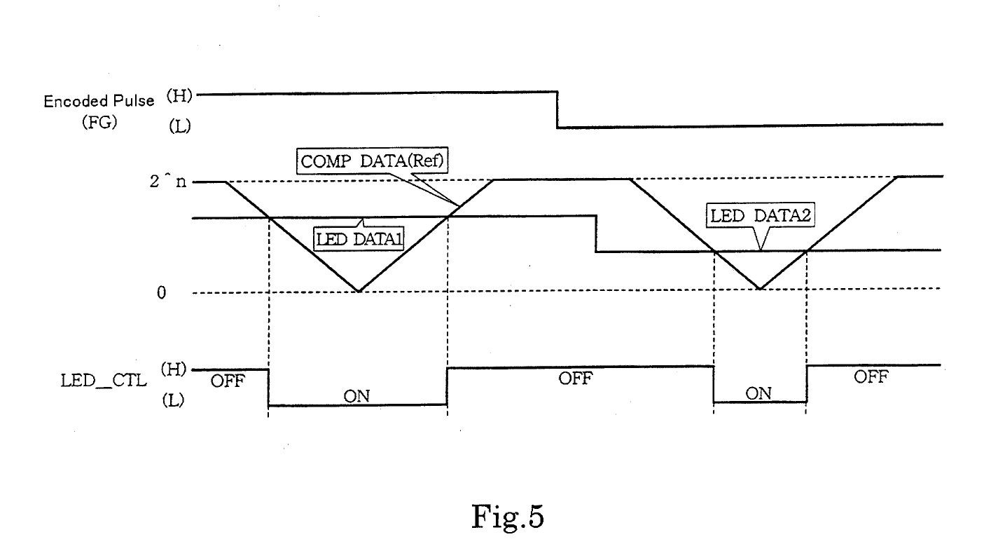

For example, as shown in the timing chart in FIG. 5, an n-bit counter is used to generate the comparative data “COMP DATA.” The counter is synchronized with the encoded pulse “FG” and repeats a countdown from (2ˆ n)−1 to 0 and a count-up from 0 to (2ˆ n)−1 by turns. This down/up operation of the counter is expressed in the timing chart in FIG. 5 by a triangular waveform. It is to be noted that while in the present embodiment a value of n is equal to eight, such a value is not limited to eight.

In addition, as mentioned above, since one cycle of the encoded pulse “FG” corresponds to a time required for moving over two dots of an image in the main scanning direction, the above-mentioned operation of the counter is carried out for both the duration when the level of the encoded pulse “FG” is high and the duration when the level of the encoded pulse “FG” is low.

The first group of registers REG1 and the second group of registers REG2 includes a number of registers equal to that of LEDs mounted on the LED head 22, respectively. Likewise, the group of comparators 38 includes a number of comparators equal to that of LEDs mounted on the LED head 22. In the present embodiment, since a total of nine LEDs including three R-LEDs, three G-LEDs and three B-LEDs are mounted on the LED head 22, the first group of registers REG1 includes nine first registers, and the second group of registers REG2 includes nine second registers. Also, the group of comparators 38 includes nine comparators “Compare.”

The first group of registers REG1 is used to set the image data “LED DATA” corresponding to each of the LEDs R1-R3, G1-G3, and B1-B3 that are mounted on the LED head 22. The image data “LED DATA” is sent from the microcomputer 16 to the gate IC 18 via the data bus “DATA.”

As mentioned above, the first group of registers REG1 includes nine first registers; while in FIG. 4, the group includes: the first registers R1REG1, R2REG1, and R3REG1 to hold the image data “LED DATA” corresponding to three LEDs R1, R2, and R3 for emitting red light; the first registers G1REG1, G2REG1, and G3REG1 to hold the image data “LED DATA” corresponding to three LEDs G1, G2, and G3 for emitting green light; and the first registers B1REG1, B2REG1, and B3REG1 to hold the image data “LED DATA” corresponding to three LEDs B1, B2, and B3 for emitting blue light.

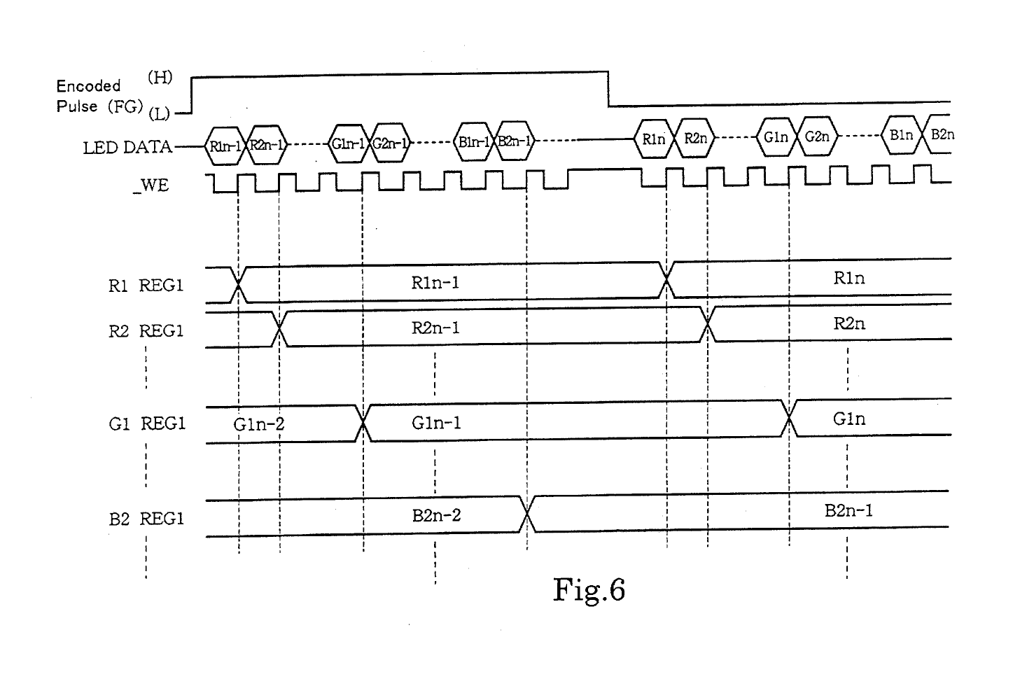

In the first group of registers REG1, as shown in the timing chart in FIG. 6, the image data “LED DATA” corresponding to nine LEDs R1-R3, G1-G3, and B1-B3 is sequentially set in the first register selected by the enable signal “ENA” in synchronization with both the encoded pulse “FG” and the rising edge of a write enable signal “_WE,” which is input by the microcomputer 16.

In this way, image data “LED DATA” corresponding to a total of nine LEDs R1-R3, G1-G3, and B1-B3 mounted on the LED head 22 is sequentially set in the first registers R1REG1-R3REG1, G1REG1-G3REG1, and B1REG1-B3REG1 by means of the microcomputer 16.

In addition, as mentioned above, since one cycle of the encoded pulse “FG” corresponds to a time required for moving over two dots of the image in the main scanning direction, the setup of the image data from the microcomputer 16 to the first group of registers REG1 is carried out for a durations when the level of the encoded pulse “FG” is high and when the level of the encoded pulse “FG” is low.

On the other hand, the second group of registers REG2 is used to hold the image data “LED DATA” corresponding to each of the nine LEDs R1-R3, G1-G3, and B1-B3 in parallel, which has been sequentially set in the first group of registers REG1.

The second group of registers REG2 includes nine second registers as mentioned above. In FIG. 4, they include the second registers R1REG2, R2REG2, and R3REG2 to hold the image data “LED DATA” corresponding to three LEDs R1, R2, and R3 for emitting red light; the second registers G1REG2, G2REG2, and G3REG2 to hold the image data “LED DATA” corresponding to three LEDs G1, G2, and G3 for emitting green light; and the second registers B1REG2, B2REG2, and B3REG2 to hold the image data “LED DATA” corresponding to three LEDs B1, B2, and B3 for emitting blue light.

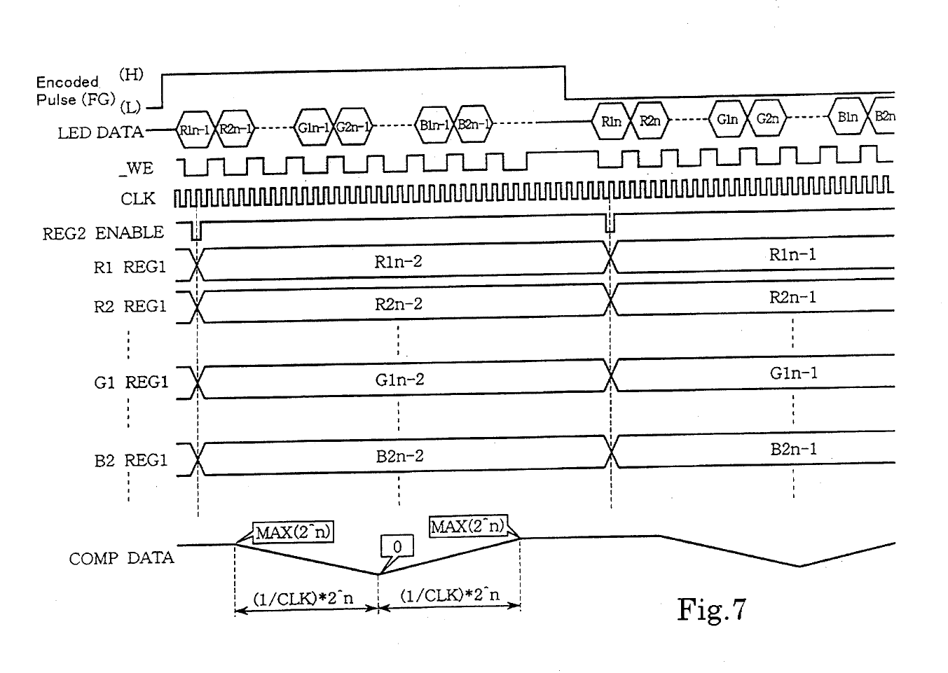

In the second group of registers REG2, as shown in the timing chart in FIG. 7, the image data “LED DATA” corresponding to nine LEDs R1-R3, G1-G3, and B1-B3, which was set in the first group of registers REG1, is held (shifted) in parallel by being synchronized with the encoded pulse “FG,” and being synchronized with the rising edge of the clock signal “CLK” sent from the oscillator 12 while the level of the enable signal “ENA” is low.

Namely, the image data “LED DATA” corresponding to the total of nine LEDs R1-R3, G1-G3, and B1-B3, which was respectively set in the first group of registers R1REG1-R3REG1, G1REG1-G3REG1, and B1REG1-B3REG1, is held in the second group of registers R1REG2-R3REG2, G1REG2-G3REG2, and B1REG2-B3REG2 in parallel.

As mentioned above, since one cycle of the encoded pulse “FG” corresponds to a time required for moving over two dots of the image in the main scanning direction, the transfer (shift) of the image data from the first group of registers REG1 to the second group of registers REG2 is carried out for a duration when a level of the encoded pulse “FG” is high and when a level of the encoded pulse “FG” is low.

As can be seen from the timing charts in FIGS. 6 and 7, the setting of the image data from the microcomputer 16 in the first group of registers REG1 is carried out in parallel with holding of the image data in the second group of registers REG2, and emission of the LEDs (exposure to a printing paper).

Concretely, the image data for the (n−2)th exposure is held in the second group of registers REG2, and the image data for the (n−1)th exposure (next exposure) is set in the first group of registers REG1 by the microcomputer 16 while the (n−2)th exposure is carried out on the basis of the image data for the (n−2)th exposure.

After setting of the image data and exposure are completed, the image data set in the first group of registers REG1 is transferred to the second group of registers REG2, and held in the second group of registers REG2.

The (n−1)th exposure and the setup of the image data for the nth exposure to the first group of registers REG1 by means of the microcomputer 16 are then carried out. Subsequently, the operations mentioned above are repeated.

In this way, since the printer 10 has the second group of registers REG2, the data held in the first group of registers REG1 can be held in the second group of registers REG2 at the transition of the encoded pulse “FG.”Therefore, since the image data held in the second group of registers REG2 is used for driving LEDs, the microcomputer 16 can set subsequent image data in the first group of registers REG1 after detecting the transition of the encoded pulse “FG.”

Namely, since the printer 10 has a structure such that the first group of registers REG1 for setting the image data and the second group of registers REG2 for driving the LEDs are separated, the printer 10 need only set the subsequent image data while exposing one dot (during one exposure). Therefore, even if an inexpensive microcomputer with a low processing speed is used as the microcomputer 16, so long as a reasonable memory capacity is available it is a plurality of image data in the LED head 22 reliably. Thus, the printer 10 can readily provide both high speed and high-resolution printing.

Next, each comparator “Compare” of the group of comparators 38 outputs to an LED driver 20 an LED control signal “LED_CTL” for controlling the LED driver 20.

In this case, a printing on/off signal “PRINT_ON/OFF” for switching between a printing state and a non-printing state is input by the microcomputer 16 to each comparator of the group of comparators 38, and the image data “LED DATA” is input by a corresponding second register in the second group of registers REG2 to each comparator of the group of comparators 38. The comparative data “COMP DATA” is also input by the LED control circuit 36 to each comparator of the group of comparators 38. Each comparator “Compare” compares the image data “LED DATA” held in the second group of registers REG2 with the comparative data “COMP DATA” input by the LED control circuit 36, and outputs an LED control signal “LED_CTL” for controlling the LED driver 20 on the basis of a comparative result and “PRINT_ON/OFF” signal received from the microcomputer 16.

As shown in the timing chart in FIG. 5, the level of the LED control signal “LED_CTL” becomes low when the level of the image data “LED DATA” is higher than that of the comparative data “COMP DATA,” and also when the level of the “PRINT_ON/OFF” signal is low, which indicates that the printer 10 is in the printing state. The LEDs emit light when the level of the LED control signal “LED_CTL” is low.

In addition, the polarity of the LED control signal “LED_CTL” is not limited to either low or high. In contrast to the present embodiment, it should be noted that the LEDs are able to emit light when the level of the polarity of the LED control signal “LED_CTL” is high.

In the Cycolor type printer 10 of the present embodiment, a photosensitive printing paper is placed close to and opposing to the LED head 22. The printer 10 exposes the photosensitive printing paper by moving the LED head 22 in the main scanning direction, and simultaneously emits light with each color corresponding to the image data to the photosensitive printing paper. When the LED head 22 arrives at one end of the printing region in the photosensitive printing paper, the photosensitive printing paper is moved by a predetermined number of dots in the sub scanning direction. Similarly, the LED head 22 is moved in the main scanning direction, and the printer 10 emits light with each color corresponding to the image data to the photosensitive printing paper. Subsequently, the operations mentioned above are repeated.

Thus, the photosensitive printing paper is two-dimensionally exposed by means of the LED head 22, whereby the latent image is recorded on the photosensitive printing paper.

In the exposure step, the encoded pulses FG1 and FG2 are generated by means of the encoder and the sensor 28, as the LED head 22 is moving. The LR signal is then generated on the basis of the encoded pulses FG1 and FG2 in the gate IC 18. The microcomputer 16 calculates coordinate positions of the nine LEDs R1-R3, G1-G3, and B1-B3, which are provided (mounted) on the LED head 22, on the basis of these encoded pulses FG1 and FG2 and the LR signal. Then, the microcomputer 16 reads out image data corresponding to the calculated coordinate position of each of the LEDs R1-R3, G1-G3, and B1-B3 from the memory 14, and sequentially sets the image data read out from the memory 14 to the first group of registers REG1 in the gate IC 18.

In the development step, the portion in the photosensitive printing paper in which the exposure was completed is mechanically subject to pressure by being interposed between the pressure mechanism 222 and a pressed surface (not shown), whereby an image based on the image data in the memory 14 is developed. In this way, image data can be developed over the entire area of the photosensitive printing paper by simultaneously moving the LED head 22 in the main scanning direction and moving the photosensitive printing paper in the sub scanning direction.

In the development step, microcapsules that remain soft are crushed by the pressure mechanism 222 on the pressed surface, causing the ink in the crushed microcapsules to be mixed so that the photosensitive printing paper is colored in accordance with the image data, and a desired image is reproduced on the photosensitive printing paper.

Then, the developed printing paper is heated by means of the heater 32, to thereby fix the image on the printing paper. At this point, the printing process (printing job) is completed.

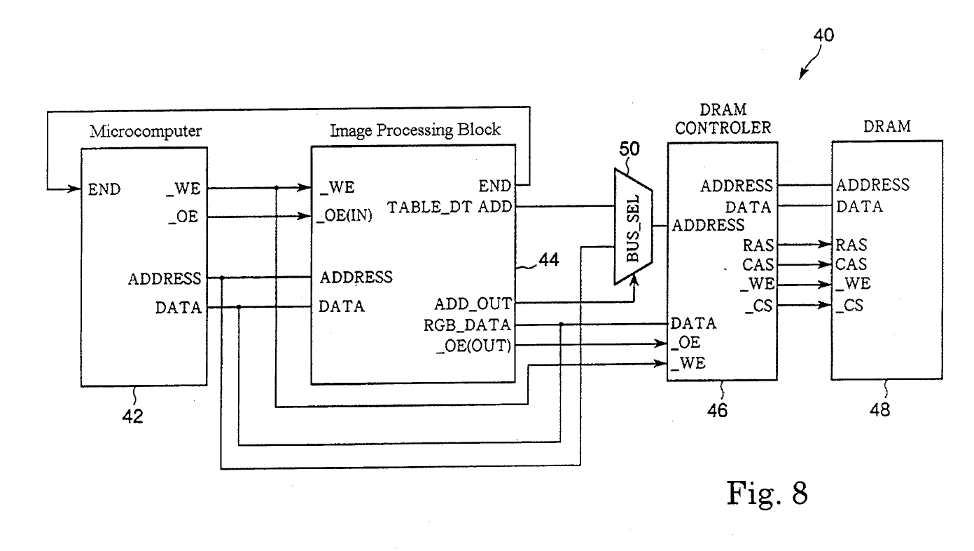

Next, an image processing circuit (image processing means) of the printer 10 shown in FIG. 1 in the present invention will be described. FIG. 8 is a block diagram illustrating one embodiment of an image processing circuit in a printer according to the present invention.

The image processing circuit (image processing means) 40 shown in FIG. 8 carries out various types of image processing such as color conversion processing for equalizing (matching) printed image color with image color appearing on a display (not shown) on the basis of image data for indicating in response to color characteristics of the printer 10. The image processing circuit 40 comprises: a microcomputer 42; an image processing block 44; a DRAM controller 46; and a DRAM (Dynamic Random-Access Memory, semiconductor memory) 48.

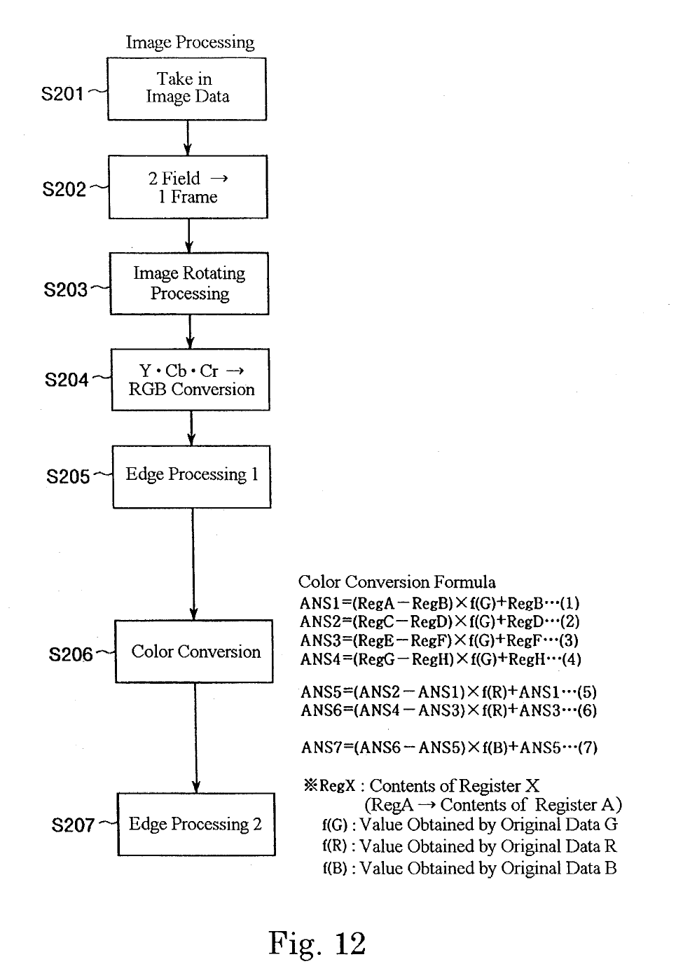

Here, the microcomputer 42 is a section for carrying out image processing in the image processing shown in a flowchart of FIG. 12, except for color conversion (color conversion processing) (in step S206), by means of software processing. If color conversion processing is carried out with respect to image data R, G and B, the microcomputer 42 transfers original image data R, G and B (image data to be converted) to the image processing block 44, and receives image data R, G and B after color conversion processing, which is processed by the image processing block 44.

The microcomputer 42 may be dedicated for the image processing circuit 40, but it is preferred to share the microcomputer 16 shown in FIG. 1. In this way, a complexity and cost of the printer 10 can be reduced.

The image processing block 44 receives the original image data R, G and B from the microcomputer 42, carries out color conversion processing according to the color conversion formulas (1)-(7) mentioned above by using hard processing, and delivers the converted image data R, G and B to the microcomputer 42. The image processing block 44 may comprise one or more ASICs (Application Specific Integrated Circuits), gate arrays, FPGAs (Field Programmable Gate Arrays), and so on.

The DRAM 48 stores compensating coefficients for converting original image data R, G and B into converted image data R, G and B for printing. The compensating coefficients have given values predetermined so as to obtain converted image data R, G and B corresponding to the color characteristics of the printer 10 according to values of the original image data R, G and B. In the present embodiment, the compensating coefficients are referred to as table data.

The table data is pre-stored in the DRAM 48 supplied from the microcomputer 42 via the DRAM controller 46.

In this case, the address signal ADDRESS output by the microcomputer 42 is output from a bus selector (BUS_SEL) 50 based on a signal ADD_OUT output from the image processing block 44, and delivered to the DRAM controller 46. Also, a data signal DATA output by the microcomputer 42 is delivered to the DRAM controller 46, and the data signal (i.e., table data) is stored at a given address specified by the address signal ADDRESS based on control of the DRAM controller 46.

Upon carrying out color conversion processing, table data is read out from the DRAM 48 via the DRAM controller 46, and the table data read out is delivered to the image processing block 44.

In this case, an address signal TABLE_DT ADD that is also output from the image processing block 44 is output from the bus selector 50 based on a signal ADD_OUT output from the image processing block 44, and delivered to the DRAM controller 46. The table data stored in the address of the DRAM 48 specified by the address signal TABLE_DT ADD is then read out based on control of the DRAM controller 46, and input to a data input terminal DATA of the image processing block 44.

Since the DRAM controller 46 and the DRAM 48 are known in the prior art and their operations is known, detailed descriptions of other signals shown in FIG. 8 such as RAS, CAS, _WE, _CS, and so on are omitted.

If the printer 10 is configured so as to store the table data in the DRAM, as shown in the present embodiment, every color characteristic can be dealt with by changing table data stored in the DRAM 48.

In the present invention, a semiconductor memory in which table data is stored is not limited to a DRAM. Other RAMs such as an SRAM (Static RAM) or rewritable nonvolatile memories such as an EPROM, an EEPROM, and a flash memory may be utilized. Further, if it is not necessary to change table data, a ROM (Read-Only Memory) in which predetermined table data is pre-stored may be utilized.

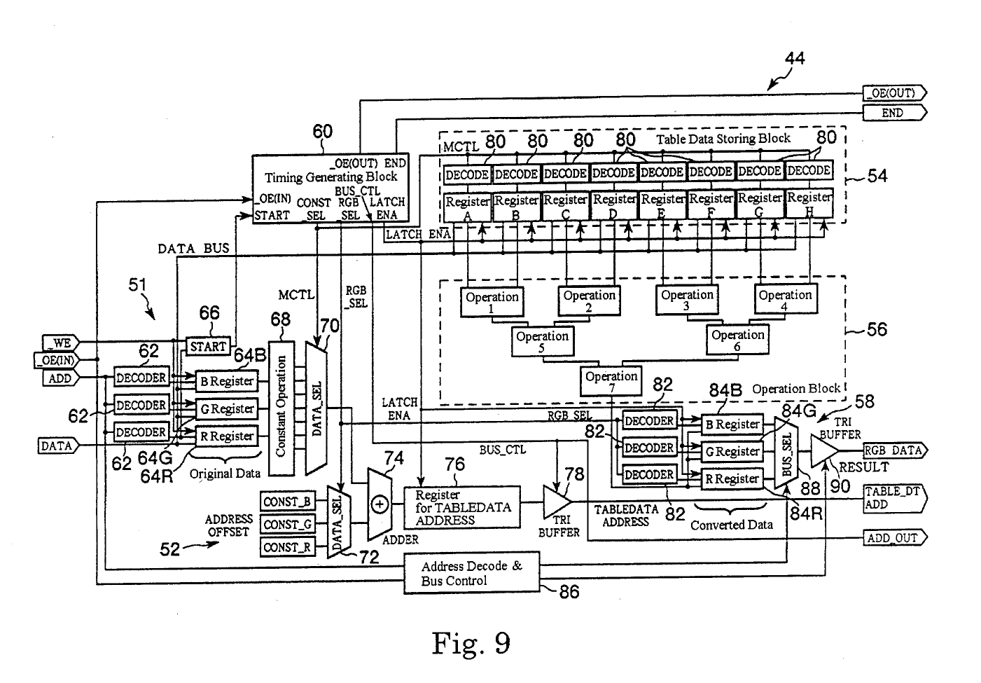

Next, the image processing block 44 will be described. FIG. 9 is a block diagram illustrating an embodiment of an image processing block in the image processing circuit of the printer according to the present invention.

The image processing block 44 shown in FIG. 9 carries out color conversion of image data according to the color conversion formulas (1)-(7) mentioned above. The image processing block comprises: an original data input block 51; an address generating block 52; a table data storing block 54; a operation block 56; a converted data output block 58; and a timing generating block 60.

In the image processing block 44 the original data input block 51 comprises: three decoders (DECODER) 62; B register 64B, G register 64G and B register 64G; a START circuit 66.

Here, each decoder 62 decodes an address signal delivered from the microcomputer 42 via the address bus ADD, and specifies B register 64B, G register 64G and R register 64R corresponding to the address signal, respectively.

B register 64B, G register 64G and R register 64R store original image data B (blue), G (green) and R (red), respectively. The original image data B, G and R delivered from the microcomputer 42 via the data bus DATA are stored in the registers (i.e., B register 64B, G register 64G and R register 64R) specified by the corresponding decoders 62 at timing of a signal_WE.

The START circuit 66 outputs a signal START at the timing of the signal_WE when the START circuit 66 detects that the original image data B, G and R are respectively set in all of the B register 64B, G register 64G and R register 64R. In the present embodiment, the original image data is configured so as to be stored in order of the B register 64B, G register 64G and R register 64R, and the START circuit 66 outputs the signal START when the original image data is stored in the last register 64R.

The signal START is a signal representing a start of color conversion processing in the image processing block 44.

In the image processing block 44 shown in FIG. 9, the address generating block 52 generates an address signal TABLE_DT ADD. The address generating block 52 comprises: a constant operation circuit 68; a data selectors (DATA_SEL) 70 and 72; an adder (ADDER) 74; a register for a table data address 76; and an output buffer (tristate buffer) (TRI BUFFER) 78.

Here, the constant operation circuit 68 carries out a constant operation for calculating an address of the DRAM 48, in which table data for converting original image data B, G and R for display, which are stored in the B register 64B, G register 64G and R register 64R respectively, into converted image data B, G and R for printing is stored.

Eight kinds of address original information for the DRAM 48, in which table data to be stored in registers A, B, C, D, E, F, G and H of the table data storing block 54, is generated in the constant operation circuit 68 in response to values of the original image data B, G and R.

The data selector 70 selectively outputs one of eight kinds of address original information of the DRAM 48 supplied from the constant operation circuit 68 in response to a signal MCTL (i.e., signal CONST_SEL) supplied from the timing generating block 60.

The signal MCTL is a signal for sequentially selecting eight registers A-H in the table data storing block 60. In the present embodiment, the registers A-H are in turn selected as the number is repeatedly changed in order of 0-7.

The data selector 72 selectively outputs one of the offset values (CONST_B, CONST_G and CONST_R: ADDRESS OFFSET) of the address of the DRAM 48 corresponding to image data B, G and R respectively in response to a signal RGB_SEL supplied from the timing generating block 60.

The signal RGB_SEL is a signal for sequentially selecting image data B, G and R. In the present embodiment, the image data B, G and R is sequentially selected in order of B, G and R as the number is repeatedly changed in order of 0-2.

The adder 74 calculates the address of the DRAM 48 in which the table data for converting original image data B, G and R into converted image data B, G and R by adding the offset value of the address of the DRAM 48 supplied from the data selector 72 to the address original information of the DRAM 48 supplied from the data selector 70.

The register for table address 76 holds an address (address signal) of the DRAM 48, which is input from the adder 74 at timing of a signal LATCH ENA supplied from the timing generating block 60.

The output buffer 78 outputs an address signal of the DRAM 48, which is input from the register for table data address 76 at timing of the signal BUS_CTL supplied from the timing generating block 60, as a signal TABLE_DT ADD (TABLEDATA ADDRESS). As shown in FIG. 8, the signal TABLE_DT ADD is used as an address signal when the table data is read out from the DRAM 48.

The table data storing block 54 in the image processing block 44 shown in FIG. 9 comprises eight decoders (DECODE) 80 and eight resisters A, B, C, D, E, F, G and H. Here, each decoder 80 decodes a signal MCTL supplied from the timing generating block 60, and specifies corresponding register A-H.

The registers A-H store a value corresponding to “RegA-RegH” in the color conversion formulas (1)-(7) mentioned above, respectively. Each table data supplied from the DRAM 48 via the data bus DATA is input in the corresponding register A-H, and the table data is stored in the registers A-H at timing of the signal LATCH ENA supplied from the timing generating block 60.

Further, the operation block 56 in the image processing block 44 shown in FIG. 9 comprises seven operation circuits 1, 2, 3, 4, 5, 6 and 7. Each of the operation circuits 1-7 carry out operations corresponding to the color conversion formulas (1)-(7) mentioned above. Output signals (output data) from the operation circuits (1)-(7) correspond to ANS 1-7, operated results of the color conversion formulas (1)-(7), respectively.

In addition, coefficients (values), i.e., f(B), f(G) and f(R) included in the color conversion formulas (1)-(7), which are obtained by given operation processing with respect to original image data B, G and R stored in the B register 64B, G register 64G and R register 64R respectively, are input to the operation circuits 1-7. This structure is omitted in FIG. 9 to avoid complications of the figure.

The converted data output block 58 comprises: three decoders (DECODER) 82; B register 84B, G register 84G and R register 84R; an address decode & bus control circuit 86; a bus selector (BUS_SEL) 88; and an output buffer (tristate buffer) (TRI BUFFER) 90.

Here, each decoder 82 decodes a signal RGB_SEL delivered from the timing generating block 60, and specifies B register 64B, G register 64G and R register 64R corresponding to the signal RGB_SEL, respectively.

B register 84B, G register 84G and R register 84R store converted image data B, G and R, respectively. The converted image data B, G and R delivered from the operation circuit 7 are respectively stored in the registers (i.e., B register 84B, G register 84G and R register 84R) specified by the corresponding decoders 82 at timing of a signal LATCH ENA supplied from the timing generating block 60.

The address decode & bus control circuit 86 decodes an address signal input from the microcomputer 42 via the address bus ADD, delivers the decoded signal to the bus selector 88. The address decode & bus control circuit 86 also delivers an output control signal to the output buffer 90 based on a signal_OE (IN) input from the microcomputer 42.

The bus selector 88 selectively outputs one of the converted image data B,G and R stored in the B register 84B, G register 84G and R register 84R respectively to the output buffer 90 in response to the decoded signal supplied from the address decode & bus control circuit 86.

The output buffer 90 outputs the converted image data B, G and R input from the bus selector 88 as a signal RGB_DATA (RESULT) at timing of the output control signal supplied from the address decode & bus control circuit 86. As shown in FIG. 8, the signal RGB_DATA is input to the DRAM 48 via the DRAM controller 46.

In the image processing block shown in FIG. 9, the timing generating block 60 generates the above-mentioned signals CONST_SEL, RGB_SEL, BUS_CTL, LATCH ENA, and so on for controlling the operations of the image processing block 44, based on the signal OE input from the microcomputer 42 and the signal START input from the START circuit. The signal BUS_CTL is output from the timing generating block 60 as the signal ADD_OUT for controlling the operation of the bus selector 50 shown in FIG. 8.

Further, the timing generating block 60 also generates a control signal_OE (OUT) for reading out the table data from the DRAM 48 and a signal END representing an end of color conversion processing, i.e., a completeness of generation of the converted image data B, G and R. As shown in FIG. 8, the signals_OE (OUT) and END are supplied to the DRAM controller 46 and the microcomputer 42, respectively.

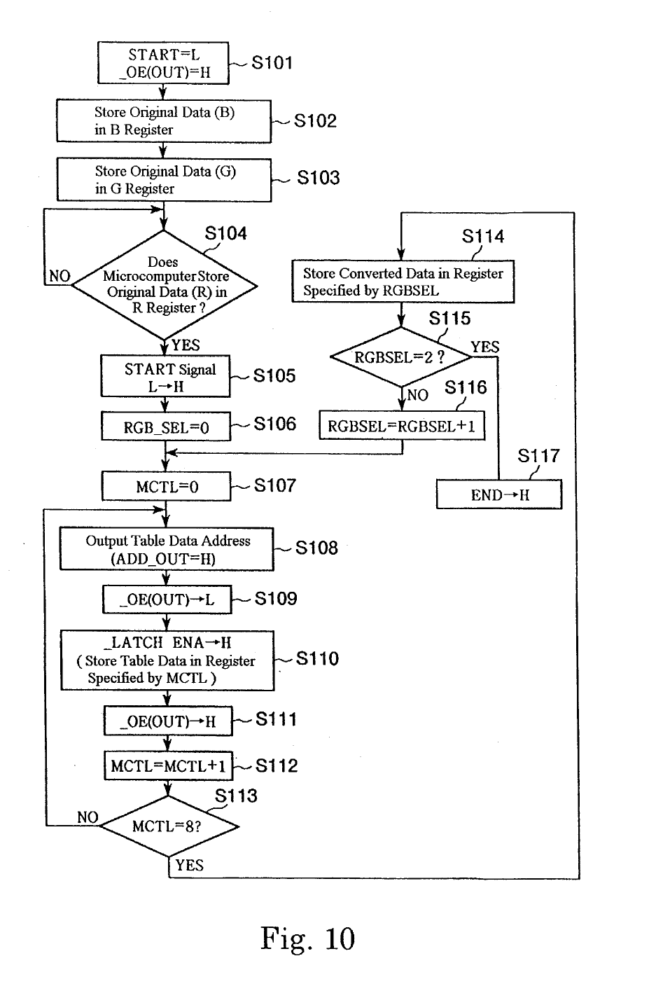

Next, operations of the image processing circuit 40 shown in FIG. 8 will be described with respect to a flowchart shown in FIG. 10.

First, before color conversion processing is carried out, in the image processing block 44 shown in FIG. 8, the signal START output from the START circuit 66 is set to low level (L), the signal_OE (OUT) output from the timing generating block 60 is set to high level (H), and the signal END is set to low level (L) (step S101).

When carrying out color conversion processing in the present embodiment, the microcomputer 42 first stores original image data B in the B register 64B (step S102).

At this stage, the address signal for specifying the B register 64B via the address bus ADD, and the image data B to be stored in the B register 64B via the data bus DATA are output to the image processing block 44. Then, in the image processing block 44, the address signal is decoded by the decoder 62, thereby specifying the B register 64B corresponding to the address signal. The image data B is stored in the B register 64B at timing of the signal_WE.

The microcomputer 42 stores original image data G in the G register 64G (step S103), and original image data R in the R register 64R (step S104) as well as the original image data B.

When the original image data R is stored in the R register 64R by the microcomputer 42 (that is, “YES” in step S104), the START circuit 66 detects the original image data R stored in the R register 64R, and a level of the signal START becomes high (step S105). Here, the START circuit 66 carries out this detecting processing repeatedly until the original image data R is stored in the R register 64R by the microcomputer 42 (that is, “NO” in step S104).

When the level of the signal START becomes high, a level of the signal RGB_SEL output from the timing generating block 60 becomes 0 (step S106), and a level of the signal MCTL (CONST_SEL) also becomes 0 (step S107).

As mentioned above, the signal RGB_SEL is a signal representing image data of image data B, G and R that is under processing. In the present embodiment, if the signal RGB_SEL becomes 0, 1 or 2, it means that the image data B, G or R is successively processed.

Further, the signal MCTL is a signal representing table data of the table data 0-7 stored in the registers A-H is under processing. In the present embodiment, if the signal MCTL becomes any one of 0-7, the table data 0-7 is successively processed.

At this time, in the address generating block 52, the address of the DRAM 48 specified by the signal RGB_SEL=0 and the signal MCTL=0 is calculated by the constant operation circuit 68, the data selectors 70 and 72, and the adder 74. The address is held in the register 76 for table data address at timing when a level of the signal LATCH ENA is high (H).

Then, a level of a signal BUS_CTL supplied from the timing generating block 60 becomes high. The address of the DRAM 48 held at the register 76 for table data address is output from the output buffer 78 as a signal TABLE_DT ADD, and the signal BUS_CTL is output from the timing generating block 60 as a signal ADD_OUT. As this point, a level of the signal ADD_OUT becomes high (H) (step S108). Further, a level of the signal_OE(OUT) output from the timing generating block 60 becomes low (L) (step S109).

A signal TABLE_DT ADD output from the image processing block 44 is selectively output from the bus selector 50 shown in FIG. 8. The table data 0 of the image data B stored in the address of the DRAM 48 corresponding to the signal TABLE_DT ADD is read out by the control of the DRAM controller 46, and input to the image processing block 44 via the data bus DATA.

The table data 0 of the image data B input to the image processing block 44 is supplied to the registers A-H in the table data storing block 54 via the data bus DATA. The signal MCTL supplied from the timing generating block 60 is decoded in the table data storing block 54 by means of the decoder 80, and a register A corresponding the signal MCTL is specified. The table data 0 is stored in the register A at timing when a level of a signal LATCH ENA supplied from the timing generating block 60 is high (step S110).

Then, the level of the signal_OE (OUT) becomes high (step S111), the value of the signal MCTL is incremented by one (that is, MCTL=MCTL+1), and the value of the signal MCTL thereby becomes one.

Here, in step S113, if the value of the signal MCTL is not 8 (that is, “NO” in step S113), the operation returns to step S108, and the above-mentioned operations are repeated. Namely, the table data 1-7 of the image data B is read out and stored in the corresponding registers B-H.

In step S113, if the value of the signal MCTL equals 8 (that is, “YES” in step S113), i.e., if all of the table data 0-7 of the image data B is stored in the corresponding registers A-H respectively, the operation processing corresponding to the color conversion formulas (1)-(7) is carried out in the operation block 56. The converted image data B that is the operated result is stored at the B register 84B of the converted data output block 58 (step S114).

At this point, the signal RGB_SEL supplied from the timing generating block 60 is decoded in the converted data output block 58 by the decoder 82, and the B register 84B corresponding to the signal RGB_SEL is specified. The converted image data B is stored in the B register 84B at timing of the signal LATCH ENA supplied from the timing generating block 60.

Next, in step S115, if a value of the signal RGB_SEL is not two (that is, “NO” in step S115), the value of the signal RGB_SEL is incremented by one (that is, RGB_SEL=RGB_SEL+1), thereby the value of the signal RGB_SEL becomes one (step S116).

Then, the operation returns to step S107, and the above-mentioned operations are repeated. Namely, in the same way as described above the converted image data G is calculated by using the operation block 56, and stored in the G register 84G, and the converted image data R is subsequently calculated and stored in the R register 84R.

In this way, the converted image data B, G and R is calculated in a time division manner system by using one operation block 56, and stored in the B register 84B, G register 84G and R register 84R, respectively.

In step S115, if the value of the RGB_SEL becomes two (that is, “YES” in step S115), namely, if the converted image data B, G and R is stored in the B register 84B, G register 84G and R register 84R respectively, a level of a signal END output from the timing generating block 60 becomes high (H) (step S117).

In the present embodiment, when the level of the signal END becomes high, the microcomputer 42 reads out the converted image data B from the image processing block 44.

At this time, an address signal for specifying the B register 84B in the converted data output block 58 and a signal_OE (IN) for controlling the read-out operation are output from the microcomputer 42 via the address data ADD, and input to the image processing block 44.

In response to this operation, the address signal is decoded in the converted data output block 58 by the address decode & bus control 86, the converted image data B stored in the B register 84B corresponding to the address signal is selectively output from the bus selector 88. Further, the converted image data B output from the bus selector 88 is output from the output buffer 90 as a signal RGB DATA at timing of an output control signal supplied from the address decode & bus control 86 on the basis of the signal_OE (IN).

The converted image data B output from the image processing block 44 is read out via the data bus DATA by means of the microcomputer 42, and is then written in the DRAM 48 via the DRAM controller 46.

The microcomputer 42 reads out the converted image data G from the image processing block 44 and stores it in the DRAM 48 as well as the converted image data B. The microcomputer 42 subsequently reads out the converted image data R and stores in the DRAM 48.

As mentioned above, the microcomputer 42 carries out color conversion processing by using the image processing block 44, and stores image data B, G and R for printing after the image data is obtained.

In the image processing circuit 40 according to the present invention, an advantage is obtained that a processing speed can be increased without the need for an expensive microcomputer, and a space-saving gate size of the image processing block 44 can be utilized according to color conversion processing. Namely, the printer of the present invention can carry out image processing in a relatively short time (at a relatively high speed) at a relatively low cost.

By way of example, if it takes around 50 seconds to carry out color conversion processing with software processing by the microcomputer 42, by using the image processing block according to the present invention, the time required can be reduced to about 15 seconds.

Further, since the image processing block 44 is shared in a time division manner in the processing of image data B, G and R, the gate size of the image processing block 44 is reduced by about a third. Also, by using the image processing block 44 according to the present invention a number of gates required in a circuit for color conversion processing can be greatly reduced, thereby enabling a structure of the circuit to be simplified, and the cost to be reduced. For example, if the image processing block 44 is configured by using circuits such as an ASIC, a gate array, an FPGA, and so on, it is possible to achieve high performance at low cost as a result of a reduction in the number of gates.

In addition, since all of the color conversion formulas (1)-(7) have an identical form, a circuit size of the operation block 56 can be further reduced by providing only one operation circuit in the operation block 56 shown in FIG. 9, and sharing this one operation circuit to carry out the operations of the color conversion formulas (1)-(7) in a time division manner.

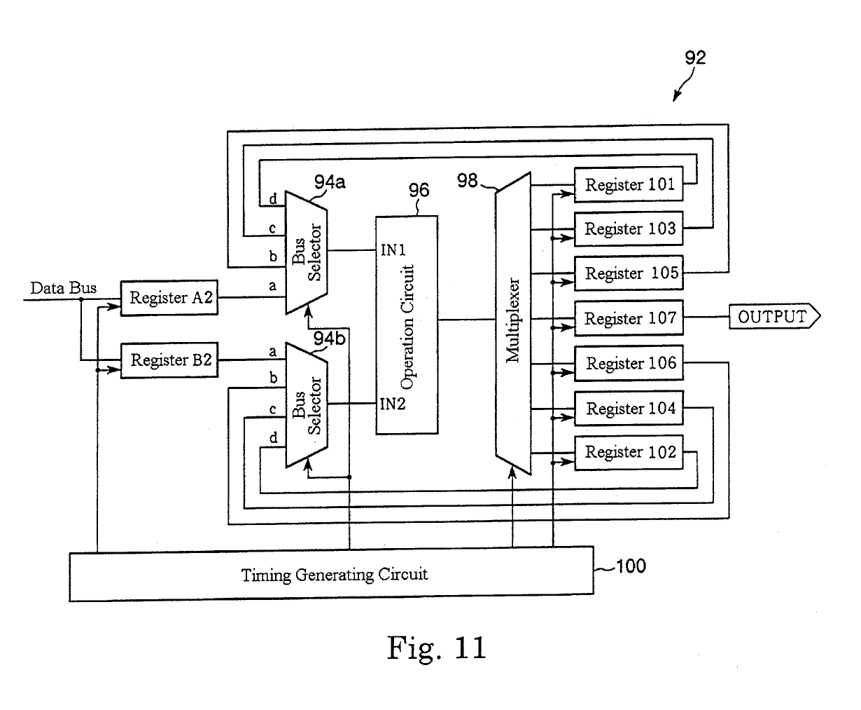

FIG. 11 is a block diagram illustrating another embodiment of an image processing block in the image processing circuit in a printer according to the present invention.

An image processing block 92 shown in FIG. 11 carries out color conversion processing of image data by sharing one operation circuit with time division and carrying out operation processing according to the color conversion formulas (1)-(7) in turn. The image processing block 92 comprises: two registers A2 and B2; two bus selectors 94a and 94b; one operation circuit 96; a multiplexer 98; seven registers 101-107; and a timing generating circuit 100.

Here, if the operation circuit 96 carries out the operation processing according to the above-mentioned color conversion formulas (1)-(7) in turn, the registers A2 and B2 hold values corresponding to two RegXs (X=A−H) that are included in the color conversion formula under operation.

The bus selector 94a selectively outputs one of output signals of the register A2 and the registers 101, 103 and 105 to the operation circuit 96. Also, the bus selector 94b selectively outputs one of output signals of the register B2 and the registers 102, 104 and 106 to the operation circuit 96.

In the present embodiment, if the operation circuit 96 is carrying out the color conversion formulas (1)-(4), the bus selectors 94a and 94b selectively output the output signals of the registers A2 and B2, respectively. On the other hand, if the operation circuit 96 is carrying out the color conversion formulas (5)-(7), the bus selectors 94a and 94b selectively output the output signals of the registers 101 and 102, which are input to input terminals d respectively, the registers 103 and 104, which are input to input terminals c respectively, and the registers 105 and 106, which are input to input terminals b respectively.

The configuration of the operation circuit 96 is identical to that of the operation circuits 1-7 shown in the operation block 56 of FIG. 9. The operation circuit 96 carries out the operation processing corresponding to the color conversion formulas (1)-(7) in turn.

Further, the registers 101-107 hold an output signal of the multiplexer 98, i.e., an output signal of the operation circuit 96 corresponding to the output signal of each of the operation circuits 1-7 of the operation block 56 shown in FIG. 9.

The timing generating circuit 100 controls operations of the registers A2 and B2, the bus selectors 94a and 94b, the multiplexer 98 and the registers 101-107, mentioned above.

As mentioned above, the operation processing corresponding to the color conversion formulas (1)-(7) is repeatedly carried out in number order in the image processing block 92 shown in FIG. 11.

First, the operation processing corresponding to the color conversion formula (1) is carried out. At this point, values corresponding to the RegA and RegB that are included in the color conversion formula (1) are respectively held in the registers A2 and B2 by the control of the timing generating circuit 100. The values of the RegA and RegB respectively held in the registers A2 and B2 are selectively output by the bus selectors 94a and 94b and supplied to the operation circuit 96.

The operation processing corresponding to the color conversion formula (1) is carried out by using the values of the RegA and RegB and a value of f(G) (not shown in FIG. 11) in the operation circuit 96. The operated result ANS1 is held in the register 101 via the multiplexer 98.

Similarly, the operation processing corresponding to the color conversion formulas (2)-(4) is carried out in the operation circuit 96, and the operated results are held in the registers 102-104, respectively.

Subsequently, the operation processing corresponding to the color conversion formula (5) is carried out in the operation circuit 96. At this point, output signals of the registers 101 and 102 are selectively output from the bus selectors 94a and 94b to the operation circuit 96 by the control of the timing generating circuit 100, respectively. The operation processing corresponding to the color conversion formula (5) is carried out by using values of ANS1 and ANS2 and a value of f(R) (not shown in FIG. 11) in the operation circuit 96. The operated result ANS5 is held in thee register 5 via the multiplexer 98.

Similarly, the operation processing corresponding to the color conversion formula (6) is carried out in the operation circuit 96, and the result of the operation processing is held in the register 106.

Finally, the operation processing corresponding to the color conversion formula (7) is carried out in the operation circuit 96. At this point, output signals of the registers 105 and 106 are selectively output from the bus selectors 94a and 94b to the operation circuit 96 by the control of the timing generating circuit 100, respectively. The operation processing corresponding to the color conversion formula (7) is carried out by using values ANS5 and ANS6 and a value of f(B) (not shown in FIG. 11) in the operation circuit 96. The operated result ANS7 is held in the register 107 via multiplexer 98.

As mentioned above, the operation processing corresponding to the color conversion formulas (1)-(7) is carried out in the image processing block 92 in turn, and the output signal corresponding to the output signal of the operation circuit 7 in the operation block 56 shown in FIG. 9 is output from the register 107.

Since the circuit size of each of the operation circuits 1-7 shown in FIG. 9 is relatively large, reducing a number of operation circuits as mentioned above has a enormous effect for reducing the circuit size.

In addition, it is possible to carry out a parallel operation by using two or more operation circuits, if necessary. If the number of operation circuits is reduced, the circuit size can be reduced, but the operation speed of the circuit decreases. On the other hand, if the number of operation circuits is increased, the operation speed of the circuit can speed up, but the circuit size becomes big (bulks up). Therefore, the number of operation circuits may be determined appropriately in view of a relation between the processing speed required and a circuit size.

Further, in the above-mentioned embodiment, the present invention has been explained by exemplifying the image processing blocks 44 and 92 to carry out color conversion processing according to the color conversion formulas (1)-(7). However, the present invention is not limited to such image processing blocks, and color conversion formulas other than the color conversion formulas (1)-(7) mentioned above may also be used.

Moreover, in the present invention, in a case that a plurality of color conversion formulas exists, it is not necessary for the color conversion formulas to have an identical form. For example, all color conversion formulas may have formulas each having one of different forms, and a part of color conversion formulas may have an identical form.

Further, a printer according to the present invention may be configured so as to carry out color conversion processing by sharing an operation block in a time division manner with respect to two-color image data of red image data R, green image data G and blue image data B.

As explained above, it is to be noted that although the printer of the present invention has been described with respect to the embodiments illustrated in the drawings, the present invention is not limited to such a structure, and various elements described above may be replaced with other elements capable of performing the same or similar functions.

For example, although the printer described in the embodiments is a cycolor type printer, the present invention is not limited to such a printer. Further, the type of printer of the present invention is not limited to a system in which a photosensitive printing paper is utilized to reproduce an image by exposure of the photosensitive printing paper.

Finally, it is to be noted that the present invention as described above with reference to the foregoing embodiments is not to be taken as being limited in any way to the description of such embodiments, and a wide range of additions and changes may be made to the present invention without departing from its spirit and scope defined in the following claims.

What is claimed is:

1. A printer having image processing means for carrying out given image processing, the image processing means comprising:
a microcomputer; and
an image processing block for carrying out color conversion processing to convert image data for color display, which is comprised of a plurality of colors, into image data for color printing, which is comprised of a plurality of colors corresponding to the plurality of colors of the image data for color display, respectively, the image processing block having an operation block for carrying out at least a part of the color conversion processing according to color conversion formulas for converting the image data for color display into the image data for color printing;
wherein said image processing means is configured so as to convert the image data for color display, which is comprised of a plurality of colors, into the image data for color printing, which is comprised of a plurality of colors corresponding to the plurality of colors of the image data for color display, respectively, using the operation block.

2. A printer having image processing means for carrying out given image processing, the image processing means comprising:
a microcomputer; and
an image processing block for carrying out color conversion processing to convert image data for color display, which is comprised of a plurality of colors, into image data for color printing, which is comprised of a plurality of colors corresponding to the plurality of colors of the image data for color display, respectively, the image processing block having an operation block for carrying out at least a part of the color conversion processing according to color conversion formulas for converting the image data for color display into image data for color printing;
wherein said image processing means is configured so as to convert the image data for color display into the image data for color printing by sharing the operation block in a time division manner.

3. A printer comprising an image processing block having an operation block for carrying out color conversion processing to convert image data for color display, which is comprised of a plurality of colors, into image data for color printing, which is comprised of a plurality of colors corresponding to the plurality of colors of the image data for color display, respectively, according to color conversion formulas for converting the image data for color display into image data for color printing, wherein said image processing means is configured so as to convert image data for color display into the image data for color printing by sharing the operation block in a time division manner.

4. The printer according to any one of claims 1-3, wherein the color conversion formulas consist of a plurality of operation formulas, and said operation block comprises at least one operation circuit for carrying out operations based on the plurality of operation formulas.

5. The printer according to claim 4, wherein the plurality of operation formulas include a plurality of operation formulas each having an identical form.

6. The printer according to claim 5, wherein said operation block comprises at least one operation circuit for carrying out operations based on the plurality of operation formulas, in which the operations are carried out sequentially by sharing the operation circuit in a time division manner.

7. The printer according to any one of claims 1-3, wherein the color conversion formulas consist of a plurality of operation formulas, and said operation block comprises a plurality of operation circuits each of which carries out an operation based on the plurality of operation formulas.

8. The printer according to claim 7, wherein the plurality of operation formulas include a plurality of operation formulas each having an identical form.

9. The printer according to any one of claims 1-3, wherein the plurality of colors include red, green and blue, and said image processing block is configured so as to carry out the color conversion processing by sharing the operation block in a time division manner for image data for at least two colors selected from red, green and blue.

10. The printer according to any one of claims 1-3, wherein the image processing block further comprises a semiconductor memory for storing compensating coefficients to be used in the color conversion formulas, and the image processing block carries out the color conversion processing according to the color conversion formulas using the compensating coefficients stored in the semiconductor memory.

11. The printer according to any one of claims 1-3, further comprising a head for exposure on which one or more light sources for emitting red light, one or more light sources for emitting green light, and one or more light sources for emitting blue light are provided;
wherein the printer is configured to reproduce an image on a photosensitive printing paper by exposing the photosensitive printing paper by means of the head for exposure.

12. The printer according to any one of claims 1-3, wherein the printer is configured so as to reproduce an image on a printing paper that contains a plurality of photosensitive microcapsules.

13. The printer according to any one of claims 1-3, wherein the printer is a Cycolor type printer.
